(19) United States
(12) Patent Application Publication
(10) Pub. No.: US 2024/0218896 A1
(43) Pub. Date: Jul. 4, 2024

(54) CONNECTING MEMBER AND ARRANGEMENT

(71) Applicants: Róbert URACS, Budapest (HU); TREND-INOVEST MAGYARORSZÁG KFT., Budapest (HU)

(72) Inventor: Róbert URACS, Budapest (HU)

(21) Appl. No.: 18/557,944

(22) PCT Filed: May 3, 2022
(86) PCT No.: PCT/HU2022/050042

§ 371 Date: Oct. 30, 2023

(30) Foreign Application Priority Data
May 3, 2021 (HU) P 21 00181

(51) Int. Cl. F16B 21/02; F16B 12/22; F16B 12/24

(52) U.S. Cl. CPC F16B 21/02; F16B 12/22; F16B 12/24

(57) ABSTRACT

A connecting member used in the furniture, toy, and construction industries. The connecting member is adapted to be mounted on a first structural element and a receiving unit adapted to be mounted on a section structure element. The connecting member also relates to the arrangement of the connecting member within structural elements. An operating unit contains a pin at one end forming a neck part and an elongated head, which together form a T-shape. The side of the neck part opposite the side facing the head part forms a collar. The operating unit includes a handle attached to the end of the pin opposite the end where the head part is formed. The receiving unit contains a plate defining an opening suitable for receiving and holding the head part and of a shape corresponding to the shape of a largest cross-section of the head part.

### TECHNICAL FIELD

The present invention relates to a connecting member that can be used especially in the furniture, toy and construction industries, which connecting member has an operating unit that can be mounted on a first structural element and a receiving unit that can be mounted on a second structural element to connect the two structural elements together. The invention also relates to an arrangement of such a connecting member within the structural elements to be connected.

In technical areas where there is a need for a relatively frequent releasable connection of two structural elements, especially in the assembly of various plates and elements used in variable furniture, toys, everyday objects, or light panels and walls used in the construction industry, it is important that the individual structural elements could safely be connected in a short time.

### BACKGROUND ART

The invention disclosed in patent document JP2014204946 is a multi-functional children's toy, in which two curved side panels 100L, 100R are connected by rods 200 and plates of diverse shapes, and various additional elements can be attached to the base unit of the product assembled in this way (the reference marks in this paragraph indicate the features of this previous solution). The essence of this solution is the design of connecting elements 300, 306, which ensure the attachment of the connecting rods 200 to the side panels 100L, 100R, enable the child to play safely, without disengaging during use. At the two ends of the connecting rods 200, 201 blind holes are formed to each receive middle pieces 300. The middle pieces are formed extending across the holes 103 formed on the side plates, where the characteristics 303, 102 of the middle piece and the hole of the side plates ensure a form-locking connection preventing the connecting rods from rotating during use. A cap 306 is placed on the threaded section 305 of the middle pieces extending beyond the side plate, where flexible elements 307 are inserted between the cap and the side plates in order to increase the friction between them. The caps also have flat 306a surfaces that allow the use of a wrench. Although the toy can be transformed with the help of the connecting elements, and thus many functions can be achieved, the variability and usability of the product is still relatively limited. In order to convert the toy, when the connecting elements are released, they must be disassembled into several parts, which, on the one hand, can cause the loss of individual parts, and on the other hand, it is a time-consuming operation that may also require a tool.

In the furniture industry, a large number of catalogs are available for selecting elements that help to connect two furniture panels (highlighted examples of this: Heavy Duty Turnlocks and IMAO Quarter-Turn Clamps sold by Anemo Engineering and DZUS® Quarter-Turn Fasteners sold by Southco). However, these are mainly used for the releasable connection of two sheets arranged parallel to each other and overlapping each other, without taking into account the need for easy and quick connection, they mostly ensure assembly and disassembly possibilities, where tools are needed.

The furniture connecting device taught in patent document EP 0036430 A1, which is considered to be the closest state of the art, has one element to be inserted into the two pieces of furniture to be connected, which are connected by a pin with a T-shaped head. After inserting the pin and turning it by a quarter turn, the T-shaped head also turns and prevents the two sheets from separating. To turn the pin, a separate tool, e.g. a screwdriver is required, it does not allow quick connection.

### SUMMARY OF THE INVENTION

With the present invention, our goal was to develop a connecting member with which structural elements, especially furniture panels, can be quickly and safely connected to each other.

Our goal has been achieved by presenting a connecting member for connecting a first structural element to a second structural element, which connecting member has an operating unit that can be mounted on the first structural element and a receiving unit that can be mounted on the second structural element; wherein the operating unit contains a pin at one end of which a neck part and an elongated head part is formed, which together form a T-shape; a collar is formed on the pin on the side of the neck part opposite its side facing the head part in the direction of the axis of the pin; further the operating unit is provided with a handle attached to the end of the pin opposite the end on which the head part is formed; furthermore, the receiving unit contains a plate, on which an opening suitable for receiving and holding the head part is formed, the shape of which corresponds to the shape of the largest cross-section of the head part.

Preferably, the operating unit comprises an elastic element arranged on the pin between the collar and the handle. The operating unit preferably includes an elastic ring arranged around the neck part, which is a rubber ring or a silicone ring. The operating unit optionally contains a ring arranged on the pin between the collar and the elastic element, which ring is preferably a seeger ring.

The elastic element is preferably selected from the elements of the following group: silicone ring, rubber ring, rubber foam ring, corrugated washer, elastic washer, spring or combinations thereof.

Preferably four protruding elements are formed on the plate of the receiving unit around the opening protruding from the inner surface of the plate, forming a nest for receiving the head part; the edges of the protruding elements are preferably rounded, further the end surface of the head part is preferably curved and/or rounded along its edges.

The handle is optionally attached to end of the pin opposite the end on which the head part is formed by means of an unreleasable connection, for example by gluing. The operating unit optionally comprises a covering plate, in which an opening is created.

The connecting member is suitable for connecting two structural elements, where both the first structural element and the second structural element can be a piece of furniture, a toy element, or a panel used in the construction industry, etc.

According to a preferred embodiment of the arrangement of the connecting member relative to the structural elements the connecting member has an operating unit mounted on the first structural element and a receiving unit mounted on the second structural element; wherein the operating unit contains a pin arranged in a hole extending from a connecting first side of the first structural element to a second side opposite the first side; as well as a handle attached to the pin at the second side of the first structural element.

A cavity is formed in the second structural element on the connecting side of the second structural element; The receiving unit includes a plate covering the cavity and being fixed to the second structural element, on which plate an opening is formed. The pin has a neck part and an elongated head part on its end at the first side the first structural element, which neck part and head part together form a T-shape; wherein the shape of the opening formed on the plate of the receiving unit which is arranged on the second structural element corresponds to the shape of the largest cross-section of the head part, and the area of which essentially corresponds to the area of the largest cross-section of the head part; further, the operating unit comprises an elastic element arranged between the second side of the first structural element and the handle

The pin has a collar formed between the neck part and the handle; and the hole includes a first section and a second section having a smaller diameter than the first section, wherein the head part and the collar are arranged in the first section.

The operating unit optionally includes an elastic ring arranged around the neck part, which is a rubber ring or a silicone ring.

The operating unit preferably further includes a ring arranged on the pin, the inner diameter of which is smaller than the diameter of the second section of the hole, and its outer diameter is greater than the diameter of the second section of the hole; wherein the ring is arranged in the first section of the hole, and wherein the ring is preferably a seeger ring.

The elastic element is preferably selected from the elements of the following group: silicone ring, rubber ring, rubber foam ring, corrugated washer, elastic washer, spring or combinations thereof. Preferably four protruding elements are formed on the plate of the receiving unit around the opening, protruding from the inner surface of the plate, forming a nest for receiving the head part, the edges of which are rounded. The end surface of the head part is preferably curved and/or rounded along its edges.

The handle is preferably attached to the end of the pin other than the end containing the head part by means of an unreleasable connection, for example by gluing. Optionally the head part is arranged to extend from the first structural element, i.e. from the plane of its first side by 0.2-2 mm, more preferably by 0.5 mm. The operating unit optionally includes a cover plate arranged on the first side of the first structural element, which has an opening; and the head part in this case is arranged to extend from the first structural element, i.e. from the cover plate by 0.2-2, more preferably by 0.5 mm. The second structural element is optionally a sheet and the plate is fixed to the second structural element by a pair of furniture screws.

### BRIEF DESCRIPTION OF THE DRAWINGS

In the following, the invention will be described in detail with the help of the drawing, in the drawing

FIG. 1.a-b are side and cross-sectional views of the connecting member according to the invention in the disconnected state, on the structural elements to be connected,

FIG. 1.c-d are side and cross-sectional views of the connecting member in the connected state, on the connected structural elements,

FIG. 2.a-b are perspective representations of the connecting member,

FIG. 3.a-d show the pin of the operating unit of the connecting member and the plate of the receiving unit that receives and holds the pin during the connection process,

FIG. 4.a-b are cross-sectional and perspective representations of the versions of the connecting member and its elements without a (seeger) ring,

FIG. 5.a-b are cross-sectional representations of the elastic ring and spring design of the connecting member in the open and closed state,

FIG. 6.a-b show the pin of the operating unit of the connecting member, as well as the plate of the receiving unit that accommodates and holds the pin in a side view and axonometrically, with the elastic ring arranged on the neck part of the pin,

FIG. 7.a-b, the use of a connecting member for the connection of typical furniture panels, with a positioning element pair.

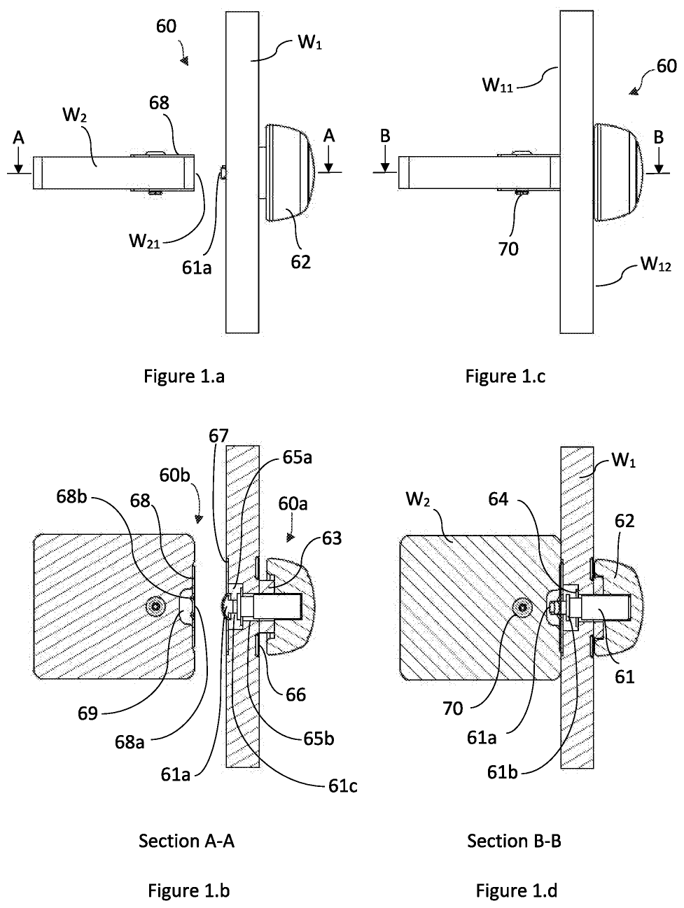

FIG. 1.a-d illustrate a preferred embodiment of the connecting member 60 according to the invention and its arrangement in and on the elements to be connected.

### DETAILED DESCRIPTION

The connecting member 60 is suitable for connecting two structural elements, in the Figures these are generally marked with plates W₁ and W₂ to be connected. Although in FIGS. 1.a-d, 2.a-b, 3.a-d and 4.a-b we illustrate the structure of the connecting member 60 through the connection of sheet-like structural elements W₁, W₂, it can also be used for a block-like element, the simplest way being the adaptation of the plate 68 of the receiving unit 60b onto a block-like element, as detailed later.

As indicated in FIG. 1.a-b, the connecting member 60 consists of two units, on the one hand, the operating unit 60a arranged in the element W₁ and associated with it, and on the other hand, the receiving unit 60b arranged and associated with the element W₂. The side view shown in FIG. 1.a and the section taken on the A-A line in FIG. 1.b show a state where the two elements W₁, W₂ are not yet connected. In the side view FIG. 1.c, as well as in the section according to FIG. 1.d taken along line B-B, the connected state of the two elements W₁, W₂ can be seen, so in this case—as detailed later—the pin 61 has already been pushed into the cavity 69, and its 90-degree turning by the handle 62 has already been done.

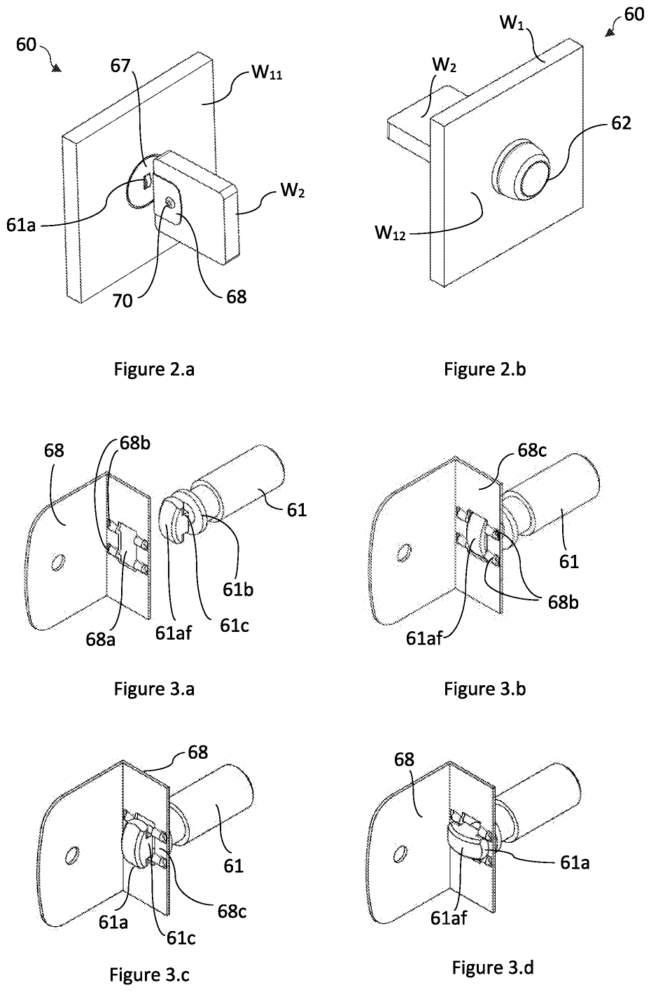

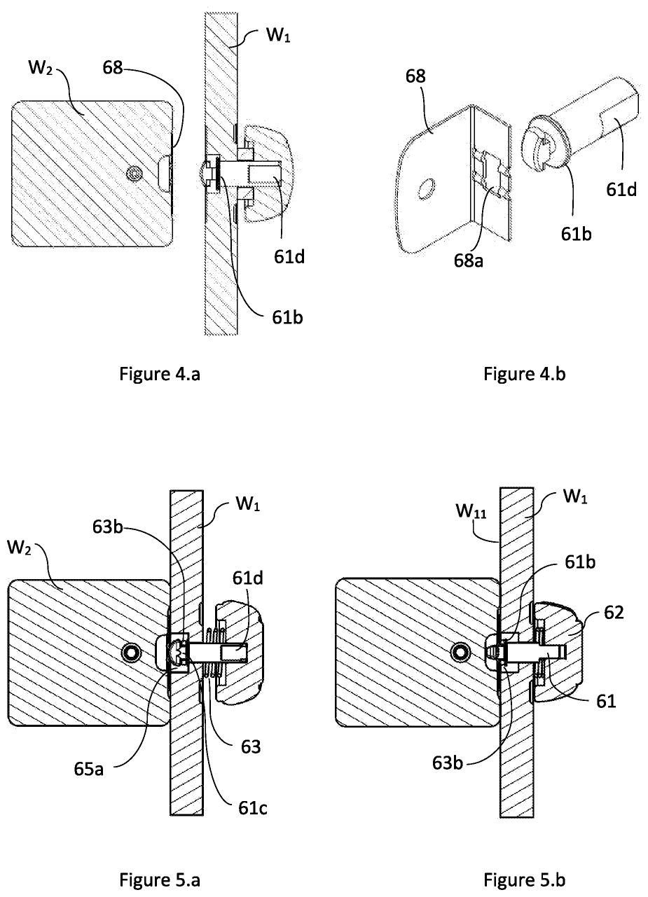

The operating unit 60a contains a pin 61, which extends slightly, approximately 0.2-2 mm, preferably 0.5 mm, on the first connecting side W₁₁ of the element W₁; and on the second side W₁₂ of the element W₁, which is opposite the first side W₁₁ thereof, it extends to an even greater extent. An elastic element 63 is attached to the section of the pin 61 extending beyond the second side W₁₂ of element W₁, and for safety reasons, a rounded operating handle 62 is fixed with an unreleasable connection (for example, by gluing, or by notching the surfaces and then pressing them; FIG. 2.b). In this way, the handle 62 has a (blind) hole for receiving the pin 61, as well as an indentation that ideally ensures the movement of the elastic element 63 on the pin 61 and its extension in the axial direction due to pressure. A groove 66 is formed on the second side W₁₂ of the element W₁ to receive a handle rim created after forming this indentation and also for its firm fit. For the (partial) form-locking, anti-rotational connection of the pin 61 in the handle 62, these parts have at least one sided flattening 61d, as shown in FIG. 4.a-b.

A head part 61a and a neck part 61c are formed at the end of the pin W₁ element 61 towards the first side W₁₁, which neck part 61c and head part 61a together form a T-shape. Furthermore, a collar 61b is preferably formed on the pin 61 in order to keep the operating unit 60a in the element W₁. To perform their function, the parts 61a-c are placed in a hole section 65a formed in the element W₁. During operation the pin 61 itself moves in the through hole formed in the element W₁ consisting of a first section 65a and a second section 65b. The falling out of the pin 61 is basically prevented by the collar 61b, and to enhance this by a ring 64, e.g. by a seeger ring arranged between a back wall of the hole section 65a. The ring 64 can even be omitted if the diameter of the collar 61b ensures that the operating unit 60a does not fall out of the element W₁. FIG. 4.a-b show the version without ring 64. The pin 61 is rotationally symmetrical over most of its length, but the head part 61a has a flattened design on two sides. The curved head part 61a formed in this way, rounded on its end surface 61af and along its edges, with the appropriate dimensions, protrudes to the mentioned extent from the opening of the plate 67 arranged on the first side W₁₁ of the element W₁ (FIGS. 1.b and 2.a). The flexible element 63 can be, among others, a spring, silicone ring, rubber ring, rubber foam ring, corrugated washer, flexible washer, pair of lens-shaped, air-trapping plates, etc., which can be pulled onto the pin 61 or fitted to it.

The other part of the connecting member 60 is the receiving unit 60b arranged on the element W₂. The unit 60b contains a cavity 69 formed in the element W₂, on its side W₂₁ facing the structural element W₁, suitable for receiving the head part 61a, as well as a plate 68 covering the cavity 69, fixed to the element W₂. If element W₂ is a sheet, then the plate 68 is ideally a plate bent into a U-shape, as illustrated in FIGS. 1.a-d and 2.a, which surrounds the element W₂, and with a fastening pair 70 (which is preferably a pair of fastening elements used for furniture) is attached to the sheet W₂ (i.e. element W₂). An opening 68a is cut out on the plate 68 (FIGS. 1.b and 3.a), around which on the inner surface 68c of the plate 68, on the side facing element W₂, preferably four, preferably semi-cylindrical protrusions 68b, protruding elements are formed as shown in FIG. 3.a-d. In general, four protruding elements 68b are formed on the plate 68 of the receiving unit 60b, around the opening 68a, forming a nest for receiving the head part 61a, the edges of which are rounded.

In the course of the connection of the elements W₁ and W₂ to each other, the pin 61 of the unit 60a is pushed into the cavity 69 of the receiving unit 60b, during which it passes through the opening 68a. After passing through, by turning the handle 62 by a quarter turn (90 degrees), the pin 61 and thus its head part 61a also rotates—this process can be seen in FIG. 3.a-d—and the head part 61a fits into the position (nest) defined by the four protruding elements 68b. Due to the curved design of the head part 61a and the protruding elements 68b, these two types of elements 61a, 68b easily roll on each other's surfaces, so that both connecting and disconnecting ensure a firm, reliable connection, and by applying the appropriate force and torque—which can be exerted by an adult—these are easily manageable processes.

An important characteristic of the connecting member 60 is that, due to the retraction effect of the elastic element 63, in the connected state, the back surface of the head part 61a is stretched against the inner surface 68c of the plate 68 arranged on the receiving unit 60b, thereby providing a pulling force that prevents the connecting member 60 from loosening during use. In addition, the elastic element 63 prevents the unwanted movement (wobbling) of the elements of the unit 60a in relation to each other and to the element W₁ even when the connecting member 60 is in a disconnected state, thus avoiding large-scale wear of the elements of the unit 60a, and especially that of the element W₁, which would pose a safety risk.

When for the purpose of changing function (of the furniture, toy, etc)—after disconnecting the pin 61 and the plate 68 of the connecting member 60—a specific element W₁, W₂ is removed from the assembly of furniture, toy, utility object, due to the collar 61b and/or the ring 64, the disconnected parts of the connecting member 60 remain in their place, i.e. in/on the corresponding element W₁, W₂; they do not fall out or hang out of the plane of the corresponding connecting side W₁₁ W₂₁ of the element W₁, W₂ in such a way that the person using the given furniture, toy, or household item assembly, etc. could be injured. By grasping the handle 62 on the second side W₂₁ of the structural element W₁ and turning it by a quarter circle in any direction, the two elements W₁, W₂ are disconnected or connected, let they be arranged either parallel or perpendicular with respect to each other. A great advantage of the connecting member 60 according to the invention is that it is not necessary to disassemble the entire assembly if we want to replace a specific structural element, as it is necessary to do, for example, in the solution disclosed in patent document JP2014204946 by removing its connecting rods and the middle parts arranged in them.

The cross-sectional FIG. 5.a-b show an embodiment of the connecting member 60 and its arrangement on the elements W₁ and W₂ to be connected, where an elastic ring 63b is used around the neck part 61c. In this case, it is not worth using cover plate 67. The elastic ring 63b is preferably made of rubber or silicone or any other suitable elastic material that enables connection. The use of the elastic ring 63b greatly enhances the definite and precise fitting of the head part 61a into the receiving unit 60b of the connecting member 60, and its closing after rotation. FIG. 5.a-b also show the elastic element 63 not as a silicone ring, but as a spring design. The use of the spring or silicone ring version of the elastic element 63 illustrated in the Figures is independent of whether an elastic ring 63b and/or a seeger ring 64 is used on the pin 61. FIG. 5.a shows the open (disconnected) state of the connecting member 60, and FIG. 5.b shows its closed (connected) state.

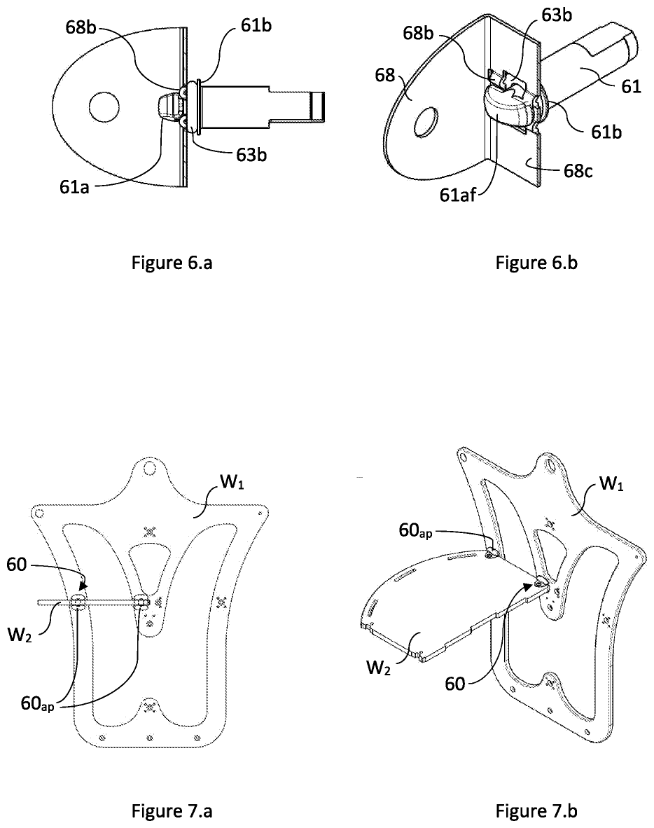

FIG. 6.a-b show the pin 61 of the operating unit 60a of the connecting member 60, as well as the plate 68 of the receiving unit 60b that receives and holds the pin 61 in a side view (FIG. 6.a) and axonometrically (FIG. 6.b); the pin 61 with the elastic ring 63b arranged on the neck part 61c, in the closed state of the connecting member 60.

In order to facilitate the connection of the elements W₁ and W₂, the connecting member 60 can easily be positioned to the cavity 69 formed on the element W₂ or to the plate opening 68a due to the small, typically 0.2-2 mm, preferably 0.5 mm protruding of the rounded head part 61a from the plane of the first side W₁₁ of element W₁. In order to make this positioning even easier, additional positioning elements 60ap can also be used where appropriate, which are especially advisable to use when connecting two sheet-like structural elements W₁ and W₂, on the first side W₁₁ of the first structural element W₁, to be placed around the head part 61a which slightly protrudes from first side W₁₁ as detailed above. Such positioning element pairs 60ap—surrounding the structural element W₂, at its given receiving unit 60b—can be seen in FIG. 7.a-b, placed at the connection points of two typical structural elements. The connecting member 60 is essentially a quick switch, it is easy for an adult to use, however, both connecting and disconnecting requires the application of forces and torques of a magnitude and direction that a child cannot exert, therefore during use or playing the disconnection of the connecting members 60 is excluded.

Advantages of the connecting member 60 according to the invention are its design enabling fast, firm and safe connection, as well as its user-friendly shape and operation that does not require special tools. A further advantage is that it is not only suitable for connecting sheets (plates) arranged parallel to each other, but also for reliably connecting sheets (plates) that are perpendicular to each other.

1. A connecting member for connecting a first structural element to a second structural element, wherein the connecting member comprises:
an operating unit mounted on the first structural element;
a receiving unit mounted on the second structural element;
wherein the operating unit comprises:
a pin;
a neck part at an end of the pin;
an elongated head part formed on the pin proximate the neck part;
wherein the neck part and the elongated head part together form a T-shape;
a collar formed on a side of the neck part of the pin opposite a side facing the head part in a direction of an axis of the pin;
a handle attached to an end of the pin opposite the end on which the head part is formed;
wherein the receiving unit comprises:
a plate defining an opening;
wherein the plate opening is suitable to receive and hold the formed head part; and
wherein a shape of the plate opening which corresponds to a shape of a largest cross-section of the head part.

2. The connecting member according to claim 1, wherein the operating unit comprises an elastic element arranged on the pin between the collar and the handle.

3. The connecting member according to claim 1, wherein the operating unit includes an elastic ring arranged around the neck part, wherein the elastic ring is one of a rubber ring and a silicone ring.

4. The connecting member according to claim 2, wherein the operating unit contains a ring arranged on the pin between the collar and the elastic element, and wherein the ring is a seeger ring.

5. The connecting member according to claim 2, wherein the elastic element is one of a silicone ring, a rubber ring, a rubber foam ring, a corrugated washer, an elastic washer, a spring and combinations thereof.

6. The connecting member according to claim 1, wherein the plate of the receiving unit includes four protruding elements disposed around a plate opening and protruding from an inner surface of the plate, and wherein the four protruding elements form a nest for receiving the head part.

7. The connecting member according to the claim 6, wherein edges of the protruding elements are rounded.

8. The connecting member according to claim 6, wherein an edge of an end surface of the head part is curved or rounded.

9. The connecting member according to claim 1, wherein the handle is non-removably attached to a first end of the pin opposite a second end on which the head part is formed.

10. A member arrangement for connecting a first structural element to a second structural element, wherein the connecting member comprises:
an operating unit mounted on the first structural element; and
a receiving unit mounted on the second structural element;
wherein the operating unit includes:
a pin arranged in a hole, wherein the hole extends from a connecting first side of the first structural element to a second side of the first structural element, wherein the second side is opposite the first side;
wherein the pin comprises a neck part and an elongated head part on an end at the first side of the first structural element, wherein the neck part and the head part together form a T-shape;
a collar formed on a side of the neck park of the pin opposite a side facing the head part in a direction of an axis of the pin;
a cavity formed on a connecting side of the second structural element;
wherein the operating unit includes a handle attached to the pin at the second side of the first structural element;
wherein the receiving unit includes a plate fixed to the second structural element and positioned to cover the cavity;
wherein the plate defines an opening suitable to receive and hold the formed head part, and wherein a shape of the opening corresponds to a shape of a largest cross-section of the head part.

11. The connecting member arrangement according to claim 10, wherein the operating unit comprises an elastic element arranged between the second side of the first structural element and the handle.

12. The connecting member arrangement according to claim 10, wherein the operating unit includes an elastic ring arranged around the neck part, and wherein the elastic ring is one of a rubber ring and a silicone ring.

13. The connecting member arrangement according to claim 10, wherein the hole comprises a first section and a second section having a smaller diameter than a diameter of the first section, and wherein the head part and the collar are arranged in the first section.

14. The connecting member arrangement according to claim 10, wherein the operating unit further includes a ring arranged on the pin;
wherein an inner diameter of the ring is smaller than a diameter of the second section of the hole;
wherein an outer diameter of the ring is greater than the diameter of the second section of the hole;
wherein the ring is arranged in the first section of the hole; and
wherein the ring is a seeger ring.

15. The connecting member arrangement according to claim 10, wherein the elastic element is one of a silicone ring, a rubber ring, a rubber foam ring, a corrugated washer, an elastic washer, a spring and combinations thereof.

16. The connecting member arrangement according to claim 10, wherein the plate of the receiving unit comprises:
four protruding elements disposed around a plate opening, and protruding from an inner surface of the plate;
wherein the four protruding elements form a nest for receiving the head part; and
wherein edges of the protruding elements are rounded.

17. The connecting member arrangement according to claim 10, wherein an edge of an end surface of the head part is curved or rounded.

18. The connecting member arrangement according to claim 10, wherein the handle is non-removably attached to an end of the pin opposite an end on which the head part is formed.

19. The connecting member arrangement according to claim 10, wherein the head part is arranged to extend from the first structural element by 0.2 mm-2 mm.

20. The connecting member arrangement according to claim 10, wherein the operating unit includes:
a cover plate arranged on the first side of the first structural element, wherein the cover plate defines an opening; and
the head part is arranged to extend from the first structural element by 0.2 mm-2 mm.

21. (canceled)
